(19) United States
(12) Patent Application Publication
(10) Pub. No.: US 2007/0011343 A1
(43) Pub. Date: Jan. 11, 2007

(54) Reducing startup latencies in IP-based A/V stream distribution

(75) Inventors: Jeffrey Davis, Snohomish, WA (US); Todd Bowra, Redmond, WA (US); Gurpratap Virdi, Bellevue, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/168,862

(22) Filed: Jun. 28, 2005

(51) Int. Cl. G06F 15/16

(52) U.S. Cl. 709/231

(57) ABSTRACT

Real-time streaming of media content from a server to a device and reduction of startup latencies during distribution are described. In one configuration, once a latency inducing event is initiated (i.e. a channel change, a stopping and starting of the streaming of live media content, or transrating to different streaming rates) a pre-roll process includes decreasing the frame rate of the media content being streamed to the monitor from an initial rate to a reduced rate. Simultaneously, a jitter buffer is flushed and rebuilt with media content samples arriving at a decoder at the initial rate, and being used for playback at the reduced rate.

### BACKGROUND

In the wake of the public's wide-spread acceptance and adoption of computers, many households and businesses are currently implementing local networks for the purpose of connecting various electrical devices. As an example, users can employ a server or host device (such as a media compatible personal computer (PC)) as an entertainment server to stream media content over a network to client devices such as a desktop PCs, notebooks, portable computers, cellular telephones, other wireless communications devices, personal digital assistants (PDA), gaming consoles, IP set-top boxes, handheld PCs, and so on. One of the benefits of streaming is that the client device(s) may render (e.g., play or display) the streaming content on devices such as stereos and video monitors situated throughout a house as the content is simultaneously received from the entertainment server, rather than waiting for all of the content or the entire “file” to be delivered.

When content is streamed over a network, it is typically streamed in data packets. Such data packets may be in a format defined by a protocol such as real time transfer protocol (RTP), and be communicated over another format such as user datagram protocol (UDP). Furthermore, such data packets may be compressed and encoded when streamed from the host device. The data packets may then be decompressed and decoded at the client device.

Media content capable of being streamed includes pictures, audio content, and audio/video (AV) content, which may be introduced to the entertainment server on portable storage media, such as CDs or DVDs, or via a tuner receiving the media content from remote sources, such as the Internet, a cable connection, or a satellite feed. Software, such as the WINDOWS XP® Media Center Edition operating system marketed by the Microsoft Corporation of Redmond, Wash., has greatly reduced the effort and cost required to transform normal home PCs into hosts capable of streaming such content.

Currently, however, problems exist when users stream live media content to be rendered on a video monitor. Since live media content is not based on a file system, it has no has no buffering. Also, streamed data packets may be received by a client device in the order that they are transmitted by the host device, or in certain cases data packets may not be received, or they may be received in a different order. Furthermore, uncertainty may exist as to the rate or flow of the received data packets. For example, data packets may arrive or be received at the client at a faster rate than the client device can render them. Alternately, data packets may not arrive fast enough for the client device to render them. In particular, the data packets may not necessarily be transmitted at a real-time rate. Thus, a jitter buffer holding a finite amount of media samples must be employed at the client device in order to smooth out network dropouts or latencies inherent in a lossy Internet protocol (IP) network.

In addition, when a user attempts actions such as changing channels, transrating to different streaming rates, or stopping and starting the streaming of live media content, a pre-roll process is conducted in real-time to allow the entertainment server to flush and rebuild the jitter buffer. During pre-roll, the device buffers incoming media samples, but no data is rendered. Rather, the data buffered during pre-roll is used to help guarantee that the renderer has a sample to render despite whatever jitter may be happening in the network. Typically, client devices allocate up to 2 seconds for the buffering of live TV scenarios, with half of this buffering being used for pre-roll.

Since the advent of cable and satellite television providers, it is not uncommon for users to have access to tens if not hundreds of channels. Often, the preferred method of reviewing the content on these channels includes channel surfing, or changing channels rapidly until favorable content is located. During streaming, the user experience may be severely frustrated if users are forced to wait a second or more for the content of each newly selected channel to be displayed.

Thus, there exists a need to decrease the influence of latency associated with channel changes, transrater reengagement and the starting and stopping of streaming, for live streams of media content being communicated to devices over a computer network.

### SUMMARY

Real-time streaming of media content from a server to a device and reduction of startup latencies during distribution are described. In one configuration, once a latency inducing event is initiated (i.e. a channel change, a stopping and starting of the streaming of live media content, or transrating to different streaming rates) a pre-roll process includes decreasing the frame rate of the media content being streamed to the monitor from an initial rate to a reduced rate. Simultaneously, a jitter buffer is flushed and rebuilt with media content samples arriving at a decoder at the initial rate, and being used for playback at the reduced rate.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical items.

FIG. 1 illustrates an exemplary home environment including an entertainment server, a home network device, and a home television.

FIG. 2 illustrates a block diagram of an entertainment server having a latency correction tool, and a home network device with which the entertainment server is communicatively coupled.

FIG. 3 is a block diagram of the latency correction tool shown in FIG. 2.

FIG. 4 is a block diagram illustrating a filter graph implemented in the latency correction tool to decrease the frame rate of streamed media content.

FIG. 5 is a flow diagram illustrating a method for hastening the construction of a jitter buffer after a latency inducing event by reducing the playback rate of media content being streamed.

FIG. 6 is a flow diagram illustrating a methodological implementation of a filter graph to reduce the rate of playback of media content being streamed in response to a latency inducing event.

### DETAILED DESCRIPTION

### Home Environment

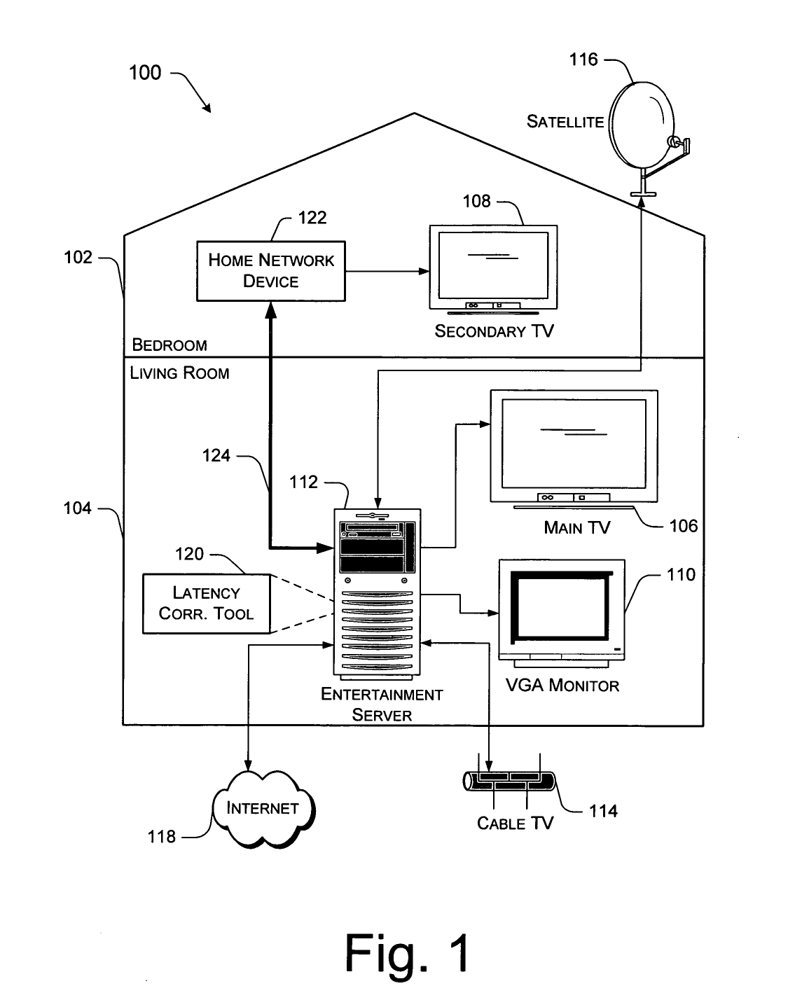

FIG. 1 shows an exemplary home environment 100 including a bedroom 102 and a living room 104. Situated throughout the home environment 100 are a plurality of monitors, such as a main TV 106, a secondary TV 108, and a VGA monitor 110. Content may be supplied to each of the monitors 106, 108, 110 over a home network from an entertainment server 112 situated in the living room 104. In one implementation, the entertainment server 112 is a conventional personal computer (PC) configured to run a multimedia software package like the Windows® XP Media Center™ edition operating system marketed by the Microsoft Corporation. In such a configuration, the entertainment server 112 is able to integrate full computing functionality with a complete home entertainment system into a single PC. For instance, a user can watch TV in one graphical window of one of the monitors 106, 108, 110 while sending email or working on a spreadsheet in another graphical window on the same monitor. In addition, the entertainment system may also include other features, such as:
A Personal Video Recorder (PVR) to capture live TV shows for future viewing or to record the future broadcast of a single program or series.
DVD playback.
An integrated view of the user's recorded content, such as TV shows, songs, pictures, and home videos.
A 14-day EPG (Electronic Program Guide).

In addition to being a conventional PC, the entertainment server 112 could also comprise a variety of other devices capable of rendering a media component including, for example, a notebook or portable computer, a tablet PC, a workstation, a mainframe computer, a server, an Internet appliance, combinations thereof, and so on. It will also be understood that the entertainment server 112 could be a set-top box capable of delivering media content to a computer where it may be streamed, or the set top box itself could stream the media content.

With the entertainment server 112, a user can watch and control a live stream of television received, for example, via cable 114, satellite 116, an antenna (not shown for the sake of graphic clarity), and/or a network such as the Internet 118. This capability is enabled by one or more tuners residing in the entertainment server 112. It will also be understood, however, that the one or more tuners may be located remote from the entertainment server 112 as well. In both cases, the user may choose a tuner to fit any particular preferences. For example, a user wishing to watch both standard definition (SD) and high definition (HD) content should employ a tuner configured for both types of contents. Alternately, the user could employ an SD tuner for SD content, and an HD tuner for HD content.

The entertainment server 112 may also enable multi-channel output for speakers (not shown for the sake of graphic clarity). This may be accomplished through the use of digital interconnect outputs, such as Sony-Philips Digital Interface Format (SPDIF) or Toslink enabling the delivery of Dolby Digital, Digital theater Sound (DTS), or Pulse Code Modulation (PCM) surround decoding.

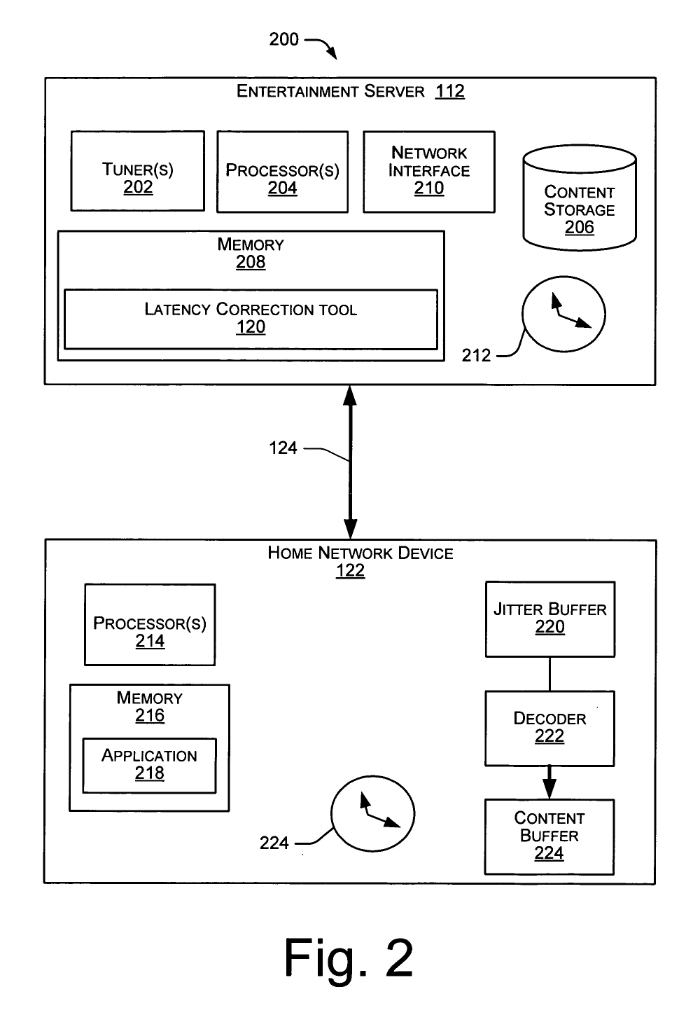

Additionally, the entertainment server 112 may include a latency correction tool 120 configured to decrease the noticeable effects of events such as channel changes, transrater reengagement and the starting and stopping of streaming, while live media content is being streamed to one of the monitors 106, 108, 110. The latency correction tool 120, and methods involving its use, will be described below in more detail in conjunction with FIGS. 2-6.

Since the entertainment server 112 may be a full function computer running an operating system, the user may also have the option to run standard computer programs (word processing, spreadsheets, etc.), send and receive emails, browse the Internet, or perform other common functions.

The home environment 100 also may include a home network device 122 placed in communication with the entertainment server 112 through a network 124. In a particular embodiment, the home network device 122 may be a Media Center Extender device marketed by the Microsoft Corporation. The home network device 122 may also be implemented as any of a variety of conventional computing devices, including, for example, a desktop PC, a notebook or portable computer, a workstation, a mainframe computer, an Internet appliance, a gaming console, a handheld PC, a cellular telephone or other wireless communications device, a personal digital assistant (PDA), a set-top box, a television, combinations thereof, and so on.

The network 124 may comprise a wire, and/or wireless network, or any other electronic coupling means, including the Internet. It will be understood that the network 124 may enable communication between the home network device 122 and the entertainment server 112 through packet-based communication protocols, such as transmission control protocol (TCP), Internet protocol (IP), real time transport protocol (RTP), and real time transport control protocol (RTCP). The home network device 122 may also be coupled to the secondary TV 108 through wireless means or conventional cables.

The home network device 122 may be configured to receive a user experience stream as well as a compressed, digital audio/video stream from the entertainment server 112. The user experience stream may be delivered in a variety of ways, including, for example, standard remote desktop protocol (RDP), graphics device interface (GDI), or hyper text markup language (HTML). The digital audio/video stream may comprise video IP, SD, and HD content, including video, audio and image files, decoded on the home network device 122 and then “mixed” with the user experience stream for output on the secondary TV 108. In one exemplary embodiment, media content is delivered to the home network device 122 in the MPEG 2 format.

In FIG. 1, only a single home network device 122 is shown. It will be understood, however, that a plurality of home network devices 122 and corresponding displays may be dispersed throughout the home environment 100, with each home network device 122 being communicatively coupled to the entertainment server 112. It will also be understood that in addition to the home network device 122 and the monitors 106, 108, 110, the entertainment server 112 may be communicatively coupled to other output peripheral devices, including components such as speakers and a printer (not shown for the sake of graphic clarity).

### Entertainment Center with Latency Correction Tool

FIG. 2 shows an exemplary architecture 200 suitable for streaming media content to the home network device 122 from the entertainment server 112. FIG. 2 shows the latency correction tool 120 as residing on the entertainment server 112. It will be understood, however, that the latency correction tool 120 need not be hosted on the entertainment server 112. For example, the latency correction tool 120 could also be hosted on a set top box, or any other electronic device or storage medium communicatively coupled to a path along which media content is conveyed on its way from a source (i.e. Internet 118, cable 114, satellite 116, antennae, etc.) to the home network device 122. This includes the possibility of the latency correction tool 120 being hosted in whole, or in part, on the home network device 122.

As noted above, the entertainment server 112 may be implemented as any of a variety of conventional computing devices, including, for example, a server, a desktop PC, a notebook or portable computer, a workstation, a mainframe computer, an Internet appliance, combinations thereof, and so on, that are configurable to stream stored and/or live media content to a client device such as the home network device 122.

The entertainment server 112 may include one or more tuners 202, one or more processors 204, a content storage 206, memory 208, and one or more network interfaces 210. The tuner(s) 202 may be configured to receive media content via sources such as cable 114, satellite 116, an antenna, or the Internet 118. The media content may be received in digital form, or it may be received in analog form and converted to digital form at any of the one or more tuners 202 or by the one or more microprocessors 204 residing on the entertainment server 112. Media content either processed and/or received (from another source) may be stored in the content storage 206. FIG. 2 shows the content storage 206 as being separate from memory 208. It will be understood, however, that content storage 206 may also be part of memory 208.

The network interface(s) 210 may enable the entertainment server 112 to send and receive commands and media content among a multitude of electric devices communicatively coupled to the network 124. For example, in the event both the entertainment server 112 and the home network device 122 are connected to the network 124, the network interface 210 may be used to stream live HD television content from the entertainment server 112 over the network 124 to the home network device 122 in real-time with media transport functionality (i.e. the home network device 122 renders the media content and the user is afforded functions such as pause, play, etc).

Requests from the home network device 122 for streaming content available on, or through, the entertainment server 112 may also be routed from the home network device 122 to the entertainment server 112 via network 124. In general, it will be understood that the network 124 is intended to represent any of a variety of conventional network topologies and types (including optical, wired and/or wireless networks), employing any of a variety of conventional network protocols (including public and/or proprietary protocols). As discussed above, network 124 may include, for example, a home network, a corporate network, the Internet, or IEEE 1394, as well as possibly at least portions of one or more local area networks (LANs) and/or wide area networks (WANs).

The entertainment server 112 can make any of a variety of data or content available for streaming to the home network device 122, including content such as audio, video, text, images, animation, and the like. The terms “streamed” or “streaming” are used to indicate that the data is provided over the network 124 to the home network device 122 and that playback of the content can begin prior to the content being delivered in its entirety. The content may be publicly available or alternatively restricted (e.g., restricted to only certain users, available only if an appropriate fee is paid, restricted to users having access to a particular network, etc.). Additionally, the content may be “on-demand” (e.g., pre-recorded, stored content of a known size) or alternatively it may include a live “broadcast” (e.g., having no known size, such as a digital representation of a concert being captured as the concert is performed and made available for streaming shortly after capture).

Memory 208 stores programs executed on the processor(s) 204 and data generated during their execution. Memory 208 may include volatile media, non-volatile media, removable media, and non-removable media. It will be understood that volatile memory may include computer-readable media such as random access memory (RAM), and non volatile memory may include read only memory (ROM). A basic input/output system (BIOS), containing the basic routines that help to transfer information between elements within the entertainment server 112, such as during start-up, may also be stored in ROM. RAM typically contains data and/or program modules that are immediately accessible to and/or presently operated on by the one or more processors 204.

The entertainment server 112 may also include other removable/non-removable, volatile/non-volatile computer storage media such as a hard disk drive for reading from and writing to a non-removable, non-volatile magnetic media, a magnetic disk drive for reading from and writing to a removable, non-volatile magnetic disk (e.g., a “floppy disk”), and an optical disk drive for reading from and/or writing to a removable, non-volatile optical disk such as a CD-ROM, DVD-ROM, or other optical media. The hard disk drive, magnetic disk drive, and optical disk drive may be each connected to a system bus (discussed more fully below) by one or more data media interfaces. Alternatively, the hard disk drive, magnetic disk drive, and optical disk drive may be connected to the system bus by one or more interfaces.

The disk drives and their associated computer-readable media provide non-volatile storage of computer readable instructions, data structures, program modules, and other data for the entertainment server 112. In addition to including a hard disk, a removable magnetic disk, and a removable optical disk, as discussed above, the memory 208 may also include other types of computer-readable media, which may store data that is accessible by a computer, like magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

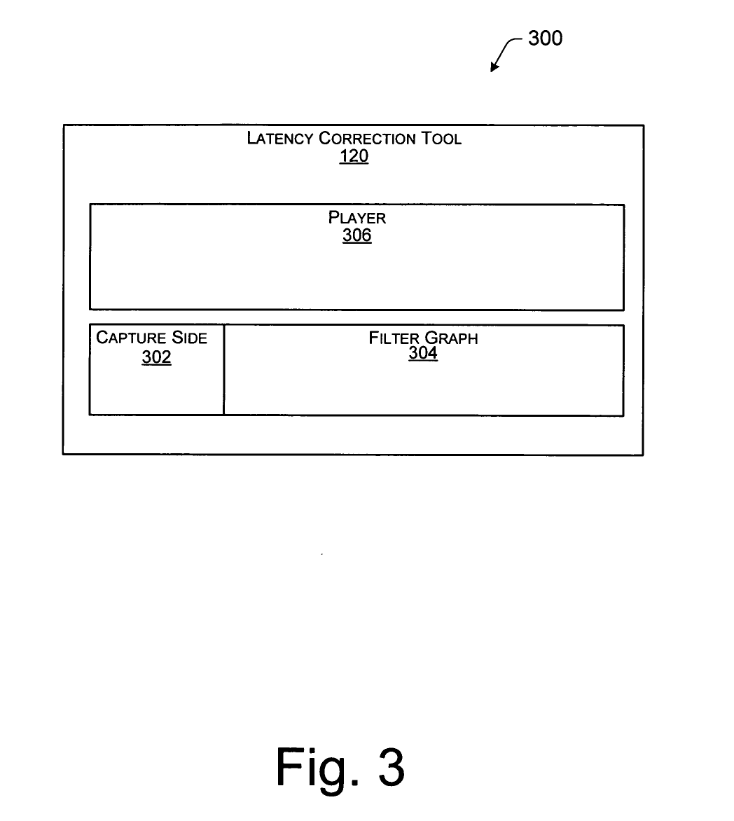

Any number of program modules may be stored on the memory 208 including, by way of example, an operating system, one or more application programs, other program modules, and program data. One such application could be the latency correction tool 120, which when executed on processor(s) 204, may create or process content streamed to the home network device 122 over network 124. The latency correction tool 120 will be discussed in more depth below with regard to FIGS. 3-6.

Entertainment server 112 may also include a system bus (not shown for the sake of graphic clarity) to communicatively couple the one or more tuners 202, the one or more processors 204, the network interface 210, and the memory 208 to one another. The system bus may include one or more of any of several types of bus structures, including a memory bus or memory controller, a peripheral bus, an accelerated graphics port, and a processor or local bus using any of a variety of bus architectures. By way of example, such architectures can include a CardBus, Personal Computer Memory Card International Association (PCMCIA), Accelerated Graphics Port (AGP), Small Computer System Interface (SCSI), Universal Serial Bus (USB), IEEE 1394, a Video Electronics Standards Association (VESA) local bus, and a Peripheral Component Interconnects (PCI) bus.

A user may enter commands and information into the entertainment server 112 via input devices such as a keyboard, pointing device (e.g., a “mouse”), microphone, joystick, game pad, satellite dish, serial port, scanner, and/or the like. These and other input devices may be connected to the one or more processors 204 via input/output interfaces that are coupled to the system bus. Additionally, they may also be connected by other interface and bus structures, such as a parallel port, game port, universal serial bus (USB) or any other connection included in the network interface 210.

In a networked environment, program modules depicted and discussed above in conjunction with the entertainment server 112 or portions thereof, may be stored in a remote memory storage device. By way of example, remote application programs may reside on a memory device of a remote computer communicatively coupled to network 124. For purposes of illustration, application programs and other executable program components—such as the operating system and the latency correction tool 120—may reside at various times in different storage components of the entertainment server 112, the home network device 122, or of a remote computer, and may be executed by one of the at least one processors 204 of the entertainment server 112, or by processors on the home network device 122 or the remote computer.

The entertainment server 112 may also include a clock 212 providing one or more functions, including issuing a time stamp on each data packet streamed from the entertainment server 112.

The exemplary home network device 122 may include one or more processors 214, and a memory 216. Memory 216 may include one or more applications 218 that consume or use media content received from sources such as the entertainment server 112. A jitter buffer 220 receives the data packets and acts as an intermediary buffer. Because of certain transmission issues including limited bandwidth and inconsistent streaming of content that lead to underflow and overflow situations, it is desirable to keep some content (i.e., data packets) in the jitter buffer 220 in order to avoid glitches or breaks in streamed content, particularly when audio/video content is being streamed.

In the implementation shown in FIG. 2, a decoder 222 may receive encoded data packets from the jitter buffer 220, and decode the data packets. In other implementations, a pre-decoder buffer (i.e., buffer placed before the decoder 222) may be incorporated. In certain cases, compressed data packets may be sent to and received by the home network device 122. For such cases, the home network device 122 may be implemented with a component that decompresses the data packets, where the component may or may not be part of decoder 222. Decompressed and decoded data packets may then be received and stored in a content buffer 224.

In an alternate implementation, it would also be possible to place two buffers before the decoder 222, with the first buffer being configured to hold data packets that incorporate real time transport protocol (RTP), and the second buffer being configured to store RTP data packet content (i.e., no RTP headers). These buffers could be included within the jitter buffer 220, or could be placed between the jitter buffer 220 and the decoder 222. In such an implementation, the second buffer need provide no content to be decoded by decoder 222. In other words, the first buffer could hold data packets with RTP encapsulation (i.e., encapsulated data content) and the second buffer could hold data packets without RTP encapsulation (i.e., de-encapsulated data content) for decoding. Content buffer 224 could also include one or more buffers to store specific types of content. For example, there could be a separate video buffer to store video content, and a separate audio buffer to store audio content. Furthermore, the jitter buffer 220 could include separate buffers to store audio and video content.

The home network device 122 may also include a clock 224 to differentiate between data packets based on unique time stamps included in each particular data packet. In other words, clock 224 may be used to play the data packets at the correct speed. In general, the data packets are played by sorting them based on time stamps that are included in the data packets and provided or issued by clock 212 of the entertainment server 112.

In operation, media content may be received in the tuner(s) 202 of the entertainment server 112 at a reception rate corresponding to the rate at which the media content may be received from a source (i.e. Internet 118, cable 114, satellite 116, antennae, etc.). It will be understood that this reception rate may be greater than, or equal to, the rate at which the media content is transmitted from the entertainment server 112 to the home network device 122 over the network 124. Additionally, the reception rate of the media content at the tuner(s) 202 may be less than the transmission rate of the media content over the network 124. In such an instance, if buffers or reservoirs are in place the transmission rate may be temporarily sustained by adding media content stored in the buffers or reservoirs to the media stream transmitted from the entertainment server 112 to the home network device 122. In a similar manner, it will also be understood that the transmission rate of the media content from the entertainment server 112 to the home network device 122 over the network 124 may be faster than, equal to, or less than the playback rate of the media content on the home network device 122.

### Latency Correction Tool and Filter Graph Functionality

FIG. 3 shows, at a high level, an exemplary architecture 300 of the latency correction tool 120. The latency correction tool 120 may, for example, be implemented as a software module stored in memory 208. Alternately, the latency correction tool 120 may reside, for example, in firmware.

In one exemplary implementation, the entertainment server 112 receives media content in digital form from the Internet 118, cable 114, satellite 116 or an antenna via one of the one or more tuners 202. The media content is subsequently captured in a capture side 302 of the latency correction tool 120 where the content may be encoded into data packets in a format suitable for streaming, and compressed. In one exemplary implementation, the media content is encoded and compressed in an MPEG-2 format. It will also be understood that the media content may be encoded and compressed by an encoder separate from the capture side 302 and the latency correction tool 120. For example, media content received at the one or more tuners 202 may be communicated to an encoder to be encoded and compressed before it is communicated to the capture side 302 of the latency correction tool 120.

After reaching the capture side 302, the encoded media content may then be communicated to a filter graph 304 pursuant to commands issued by a player 306. In instances when a pre-roll process would normally be required—such as when it is desired to change channels, transrate to different streaming rates, or stop and start the streaming of live media content—the filter graph 304 may receive commands from the player 306 to process the media content in order to secure the streaming operation against a possible degradation of picture and audio quality. The player 306 may also communicate with the home network device 122 in order to effect changes of play rate of the media content on the home network device 122.

Even though FIG. 3 shows the player 306 as being part of the latency correction tool 120, it will be understood that the player 306 may also be a stand alone application. The same can also be said of the capture side 302, which may reside either within the latency correction tool 120, or outside the latency correction tool 120 as a stand alone application. In addition, as discussed above, it will also be understood that media content received at the one or more tuners 202 may be in the form of an analog signal which may be converted to a digital signal by a converter located in the one or more tuners 202, or within the memory 208. Moreover, the media content need not be received using the one or more tuners 202. For example, existing media content may be retrieved from the content storage 206 and communicated to the capture side 302 of the latency correction tool 120 in a manner similar to that followed by media content received in the one or more tuners 202 as discussed above.

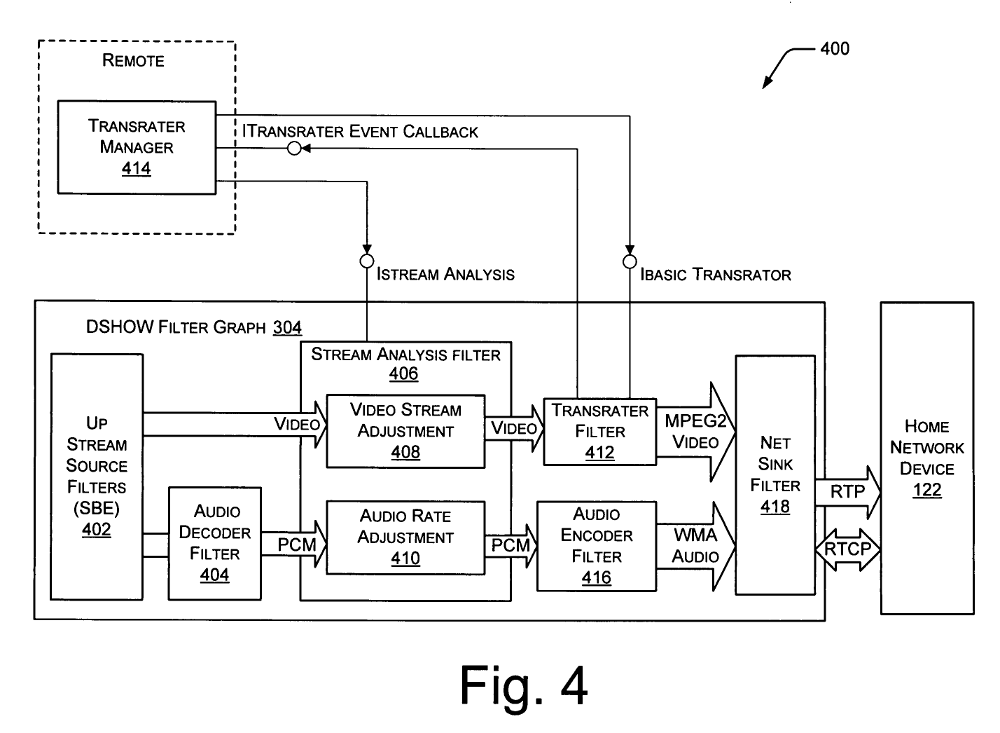

FIG. 4 shows an exemplary architecture 400 of the filter graph 304. Media content may be introduced to the filter graph 304 via upstream filters 402 which constitute a source buffering engine (SBE). The upstream filters 402 may act in a file storing capacity by receiving media content from the capture side 302 of the latency correction tool 208 and storing the content to memory, such as a hard disk, so that the content is ready to be used when needed by the player 306. For example, when media content is received by one of the at least one tuners 202 and transmitted to the latency correction tool 120 at a rate faster than it needs to be transmitted to the decoder 222 in the home network device 122, a backpressure is exerted on the upstream filters 402, which act as a reservoir where the media content can be saved as it awaits its turn to be transmitted to the home network device 122. Similarly, when media content is being received by one of the at least one tuners 202 and transmitted to the latency correction tool 120 at a rate slower than that needed to supply the decoder 222 in the home network device 122, this deficiency may be made up by allowing more media content to be streamed from the reservoir of the upstream filters 402 (for example, media content stored on a hard drive). Thus, the upstream filters 402 may also operate in a playback capacity, reading content from a memory such as a hard disk and transmitting it to decoders and renderers in the home network device 122. The upstream filters 402 may also act as a pause buffer, allowing for the storage of live streamed media content in response to a pause command entered by the user. In one exemplary implementation, the encoded and compressed media content received by the upstream filters 402 may be expressed in an MPEG 2 format. It is also possible, however, to use other encoding and compression formats.

An audio decoder filter 404 may be used to decode audio content within the media content (if any is present) into audio Pulse Code Modulation (PCM) samples. The video content and the audio PCM samples may then be communicated to a stream analysis filter 406, which includes a video stream adjustment portion 408 and an audio rate adjustment portion 410. In the instance of a latency inducing event, such as a channel change, a stopping and starting of the streaming of live media content, or transrating to different streaming rates, the player 306 may issue commands to the stream analysis filter 406 to change the video and audio context and slow down the playback rate of the media stream. In the video stream adjustment portion 408, this may entail the insertion of new video sequence headers into the packets making up the video content informing the decoder 222 that a new frame rate has been selected. In addition, video presentation timestamps on the video content packets may be normalized to the new frame rate by the video stream adjustment portion 408.

If the video content has been encoded in an MPEG 2 format, the possible playback rates include 24, 25, 29.997, 30 and 60 frames per second. In contrast, the National Television System Committee (NTSC) broadcast format mandates a frame rate of 30 frames per second, while the Phase Alternation by Line (PAL) and Systeme Electronique Couleur Avec Memoire (SECAM) broadcast formats mandate a frame rate of 25 frames per second. Thus, if media content is being streamed which is being rendered at the home network device 122 in the NTSC format, by reducing the frame rate to 24 frames per second, a 20% reduction in the playback rate at the home network device 122 can be realized. Similarly, if a reduction to 25 frames per second is selected, a reduction in the playback rate at the home network device 122 of 16.667% may be realized. It will be understood that the amount of reduction of frame rate may be preprogrammed in the entertainment server 112 or the home network device 122, or it may be received in either device as a user command, a separate signal, or as part of the media content being streamed.

Similarly, the playback rate of the audio content may also be altered to a playback rate equaling that chosen for the video content. This may be accomplished using the audio rate adjustment portion 410 which may elongate the audio PCM samples and perform pitch adjustment such that the audio playback rate is slowed to the same degree that the video playback rate has been slowed in the video stream adjustment portion 408. In addition, the audio rate adjustment portion 410 may also attach time stamps to the audio PCM samples in order to maintain the synchronization of the audio content and the video content.

In one exemplary implementation, time expansion may be used by the audio rate adjustment portion 410. Time expansion is a technology that is generally well-known to those skilled in the art that permits changes in the playback rate of audio content without causing the pitch to change. Most systems today use linear time-expansion algorithms, where audio/speech content may be uniformly time expanded. In this class of algorithms, time-expansion may be applied consistently across the entire audio stream with a given speed-up rate, without regard to the audio information contained in the audio stream. Additional benefits can be achieved from non-linear time-expansion techniques. Non-linear time expansion is an improvement on linear expansion where the content of the audio stream is analyzed and the expansion rates may vary from one point in time to another. Typically, non-linear time expansion involves an aggressive approach to expanding redundancies, such as pauses or elongated vowels.

In another exemplary implementation, a variable speed playback (VSP) system and method may be used by the audio rate adjustment portion 410. The variable speed playback (VSP) method may take a sequence of fixed-length short audio frames from an input stream of audio content, and overlap and add the frames to produce an output stream of audio content. In one implementation, the VSP system and method can use a 20 ms frame length with four or more input samples being involved for each output sample, resulting in an input-to-output ratio of 4:1 or greater. Input frames may be chosen at a high frequency (also known as oversampling). By increasing the input frame sampling frequency, the fidelity of the output audio samples may be increased—especially for music. This results because there is a great deal of dynamics and pitches in many types of music, especially symphonies, such that there is not a single pitch period. Thus, estimating a pitch period is difficult. Oversampling alleviates this difficulty.

The VSP method includes receiving an input audio signal (or audio content) containing a plurality of samples or packets in an input buffer. The VSP method processes the samples as they are received such that there is no need to have the entire audio file to begin processing. The audio packets can come from a file or from the Internet, for example. Once the packets arrive, they are appended to the end of the input buffer where the packets lose their original boundary. Packet size is irrelevant, because in the input buffer there are a continuous number of samples.

Initialization may then occur by obtaining the first frame of an output buffer. In one implementation, the first 20 ms of frame length in the input buffer may be designated as a first frame. Alternately, the frame length can be a length particular to certain content. For example, there may be an optimal frame length value for a particular piece of music. The non-overlapping portion of the first frame may then be written or copied to the output buffer.

A moving search window exists within the input samples in the input buffer that is used to select the input frames. If there are N samples in the input buffer, the user has specified a playback speed of S, and the normal playback speed is 1.0, then the output buffer should have N/S number of samples. If S=1.0, then the input and output buffers will have the same number of samples. The input is a train of samples, and a frame is a fixed-length sliding window from the train of samples. A frame may be specified by specifying a starting sample number, starting from zero. There may also be a train of samples in the output buffer.

Both the input and the output buffers contain a pointer to the beginning of the buffers and a pointer to the end of the buffers. After each new frame is overlapped with the signal in the output buffer, the output buffer beginning point O_{b} may be moved by an amount of a non-overlapping region, such as, for example, 5 ms. Then, the input buffer point initial estimate may be set to O_{b} multiplied by S. This is where a candidate for the subsequent frame may be generated.

For example, as soon as enough packets arrive in the input buffer for 20 ms of content, this 20 ms of content may be copied to the output buffer. Then, the pointer to the beginning of the output buffer O_{b} may be moved or incremented by 5 ms. This is done to overlap 4 frames together. Further, assuming the speedup factor is 2× (S=2), in order to get the 2^{nd} frame, the formula O_{b}*S=5 ms*2=10 ms may be used to estimate Fₒ, or an offset position in the input buffer for subsequent candidate input frames. Stated another way, an estimated center of the 2^{nd} candidate frame may be at 10 ms in the input buffer.

The search window may then be centered at the offset position in the input buffer. If the sum of Fₒ plus the frame length plus the neighborhood to search exceeds the pointer to the end of the input buffer (Iₑ), then not enough input exists and as a result, no output will be generated until additional content is received.

For example, continuing the example started above, if the input does not have 30 ms of samples, the VSP system and method may have to wait until 30 ms of packets have arrived before generating the 2^{nd} frame. There may also be a search window having a 30 ms window size, thus 60 ms of content may be required before the 2^{nd} frame can be output. If a file is the input, then this is not a problem, but if it is streaming audio, then the VSP system and method must wait for the packets to arrive.

The distance from 0 to O_{b} in the input buffer is the number of samples that can be output. Thus, although 20 ms of frame length may be generated for a first frame during initialization, only 5 ms of the first frame can be copied from the input to the output buffer. This is because the remaining 15 ms may need to be summed with the other three frames. The portion of the frame from 5 ms to 10 m is waiting for a part of the 2^{nd} frame, the portion of the frame from 10 ms to 15 ms is waiting for the 2^{nd} and 3^{rd} frames, and the portion of the frame from 15 ms to 20 ms is waiting for the 2^{nd}, 3^{rd} and 4^{th} frames. After each new frame is overlapped and added to the output buffer, O_{b} may be moved or incremented by the number of completed samples (in one implementation this may include 5 ms). In addition, in one implementation, a Hamming window may be used to overlap and add. The output buffer contains the frames added together.

After a frame is selected, a refinement process may be used to adjust the frame position. The goal is to find the regions with the search window that will be best matched in the overlapping regions. In other words, a starting point for the adjusted input frame may be found that best matches with the tail end of the output signal in the output buffer.

The adjustment of the frame position may be achieved using a novel enhanced correlation technique. This technique defines a cross-correlation function between each sample in the overlapping regions of the input frame that are in the search window and the tail end of the output signal. All local maxima in the overlapped regions are considered. More specifically, the local maxima of a cross-correlation function between the end of the output signal in the output buffer, and each sample in the overlapped portions in the search window of the input buffer are found. The local maxima are then weighted using a weighting function, and the local maximum having the highest weight (i.e. highest correlation score) is then selected as the cut position. The result of this technique is a continuous-sounding signal.

The weighting function may be implemented by favoring local maxima that are closer to the center of the search window and giving them more weight. In one implementation, the weighting function is a “hat” function. The slope of the weighting function may be some parameter that can be tuned. The input function may then be multiplied by the hat weighting function. In one implementation, the top of the hat is 1 and the ends of the hat are ½. At + and − WS (where WS is the search window), the weighting function=½. The hat function weights the contribution by its distance from the center. The center of the “hat” is the offset position.

The adjusted frame may then be overlapped and added to the output signal in the output buffer. Once the offset is obtained, another frame sample may be taken from the input buffer. The adjustment may be performed again, and an overlap-add may be done in the output buffer. Stated another way, the local maxima having the highest weight may be designated as a cut position at which a cut may be performed in the input buffer in order to obtain an adjusted frame. The chosen frame may then be copied from the input buffer, overlapped, and added to the end of the output buffer.

The VSP method and system may use an overlap factor of 75% of the frame length. This means that each output frame of the output signal is the result of four overlapped input frames. A determination is then made as to whether there is additional audio content. If so, then the process begins again by first moving the output buffer beginning pointer (O_{b}) by an amount of the non-overlapping region. In the example above, O_{b}=5 ms. If the end of the audio content has been reached, then the playback speed varied audio content is output.

The VSP system and method also may include a multi-channel correlation technique. Typically, music is in stereo (two channels) or 5.1 sound (six channels). In the stereo case, the left and right channels are different. The VSP system and method averages the left and right channels. The averaging occurs on the incoming signals. In order to compute the correlation function, the averaging may be performed; but the input and output buffers are still in stereo. In such a case, incoming packets are stereo packets, which are appended to the input buffer, with each sample containing two channels (left and right). When a frame is selected, the samples containing the left and right channels may be selected. Additionally, when the cross-correlation is performed, the stereo may be collapsed to mono.

An offset position may then be found, and the samples of the input buffer may be copied (where the samples still have left and right channels). The samples may then be overlapped to the output buffer. This means that the left channel may be mixed with left channel and right channel may be overlapped and added to the right channel. In the 5.1 audio case, only the first two channels need be used in producing the average for correlation—in the same manner as in the stereo case.

The VSP system and method may also include a hierarchical cross-correlation technique. This technique may be needed sometimes because the enhanced cross-correlation technique discussed above is a central processing unit (CPU) intensive operation. The cross-correlation costs are of the order of n log(n) operations. Because the sampling rate is so high, and to reduce CPU usage, the hierarchical cross-correlation technique forms sub-samples. This means the signals are converted into a lower sampling rate before the signals are fed to the enhanced cross-correlation technique. This reduces the sampling rate so that it does not exceed a CPU limit. The VSP system and method may then perform successive sub-sampling until the sampling rate is below a certain threshold. Sub-sampling may be performed by cutting the sampling rate in half every time. Once the sampling rate is below the threshold, the signal may be fed into the enhanced cross-correlation technique. The offset is then known, and using the offset the samples can be obtained from the input buffer and put into the output buffer. Another enhanced cross-correlation may be performed, another offset found, and the two offsets may be added to each other.

The VSP system and method may also include high-speed skimming of audio content. The playback speed of the VSP system and method can range from 0.5× to 16×. When the playback speed ranges from 2× to 16×, each frame may become too far apart. If the input audio is speech, for example, many words may be skipped. In high-speed skimming, frames may be selected and then the chosen frames may be compressed up to two times (if compression is sought). The rest may be thrown away. Some words may be dropped while skimming at high speed, but at least the user will hear whole words rather the word fragments.

For more explanation and examples of VSP systems and methods, please see U.S. patent application Ser. No. ______ entitled “Variable Speed of Playback of Digital Audio” by He and Florencio filed on ______.

Still looking at FIG. 4, by employing the video stream adjustment portion 408 and the audio rate adjustment portion 410, and by inducing the decoder 222 in the home network device 122 to render the audio and video content at a reduced rate, the jitter buffer 220 may be built up. For example, in the instance that an NTSC monitor is being used to display media content, under normal operation a media rendering application on the home network device 122 will render media content at 30 frames per second. Thus the media content transmitted from the entertainment server 112 to the home network device 122 over the network 124 will be consumed by the home network device 122 at 30 frames per second. After a latency inducing event, however, the decoder 222 in the home network device 122 will render the media content at a reduced rate. Thus, media content may be arriving at the home network device 122 faster than it is being used by the decoder 222 and the media rendering application on the home network device 122. It is this difference in rates that allows the jitter buffer 220 to be built up. In the NTSC example given above, if the media content playback rate is decreased to 24 frames per second, the jitter buffer 220 may be built up in 5-10 seconds, while the media content is being rendered on a monitor, maintaining a good quality user experience. This slowdown of consumption rate at the home network device 122 may also affect the upstream filters 402, since a back pressure may be formed, requiring the storage of media content arriving at the upstream filters 402.

The filter graph 304 also may include a transrater filter 412 which cooperates with a transrater manager 414 to monitor and maintain the video content being streamed through the filter graph 304. For example, the transrater manager 414 ensures that after a latency inducing event occurs, discontinuities in the stream of media content do not adversely affect downstream decoders such as the decoder 222 in the home network device 122. The transrater manager 414 accomplishes this by directing the stream analysis filter 406 to drop frames in the event of discontinuities until an iframe or a clean point in the video stream is reached. Thus, after home network device 122 has flushed its buffers in response to a latency inducing event, the first frame it receives from the filter graph 304 may be an iframe or a clean point in the stream. In FIG. 4, the transrater manager 414 is shown as being outside of the filter graph 304. It will also be understood, however, that the transrater manager 414 could be included within the filter graph 304 as well.

Audio content from the audio rate adjustment portion 410 may be received in an audio encoder filter 416, where the audio content may be converted into a Windows Media Audio (WMA) format, an MPEG-2 format, or any other packet-based format.

A net sink filter 418 may then receive both the audio content and the video content and packetize them incorporating a suitable streaming protocol such as RTP. Alternately, the net sink filter 418 may packetize the audio and video content incorporating precision time protocol (IEEE 1588) (PTP), or any other streaming compatible packetizing technology.

It will also be understood, that audio content received from the upstream filters 402 in encoded formats may be processed in the encoded format in the filter graph 304 without being decoded at the audio decoder filter 404. For example, audio content received in MPEG-2 format may be passed from the upstream filters 402 to the audio rate adjustment portion 410 without being decoded into audio PCM samples. Rather, the audio content in MPEG-2 form may be altered in the audio adjustment rate portion 410 to a playback rate equaling that chosen for the video content before being eventually passed on to the net sink filter 418.

Once the audio and video content is packetized by the net sink filter 418, the content is streamed over network 124 to the home network device 122. At the home network device 122, the audio and video content may then be decoded and decompressed in the decoder 222 before being transmitted to a player which may render the media content on a monitor 108 or through speakers.

The home network device 122 may also communicate with the filter graph 304 over network 124 through a feedback channel using a defined format or protocol such as real time transport control protocol (RTCP). In such an example, control packets that are separate from data packets may be exchanged between the entertainment server 112 and the home network device 122. In this way, control packets from the home network device 122 may provide the entertainment server 112 with information regarding the status of the streaming operation in the form of, for example, buffer fullness reports, or sender's reports. Audio/Video media control operations, such as user entered commands like start, stop, pause and channel changes, may be communicated over network 124 from the home network device 122 to the entertainment server 112 using a control channel (not shown for the sake of graphic clarity).

It will be understood that the home network device 122 may include a media device interoperating with other media devices through digital living network alliance (DLNA) requirements, as well as Media Center Extender requirements as set forth by the Microsoft Corporation.

### Latency Correction Method

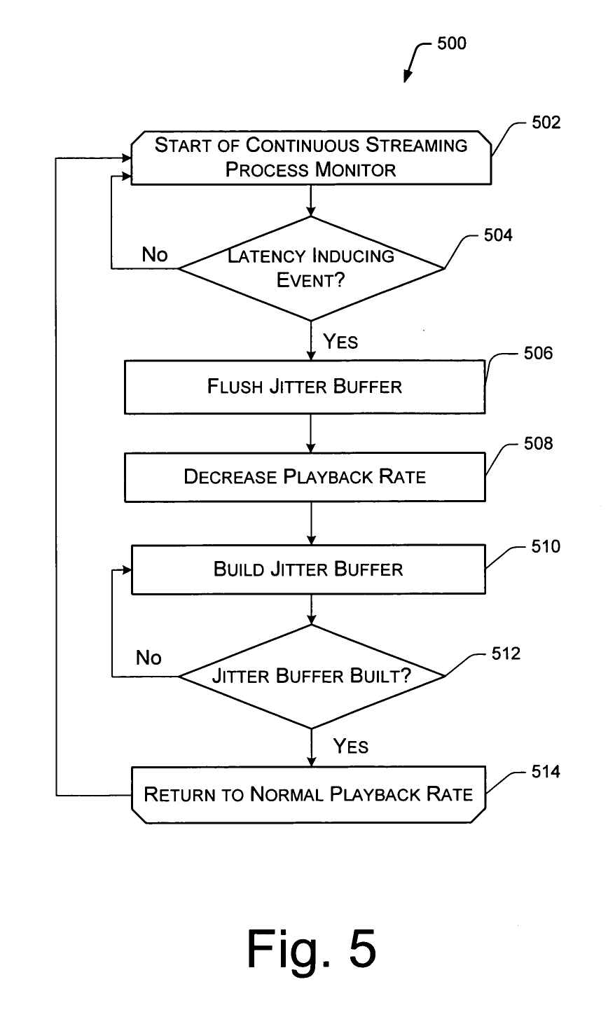

Another aspect of dealing with latency inducing events is shown in FIG. 5 which illustrates an exemplary method 500 performed by the latency correction tool 120. For ease of understanding, the method 500 is delineated as separate steps represented as independent blocks in FIG. 5; however, these separately delineated steps should not be construed as necessarily order dependent in their performance. Additionally, for discussion purposes, the method 500 is described with reference to elements in FIGS. 1-4.

The method 500 continuously monitors the status of a streaming operation at a block 502. When a latency inducing event occurs (such as a channel change, a stopping and starting of the streaming of live media content, or transrating to different streaming rates) at a block 504 (i.e. the “yes” branch), the jitter buffer 220 is flushed at a block 506. Alternately, if no latency inducing event is detected (i.e. the “no” branch from block 504), the method 500 continues to monitor the streaming process (block 502).

Once the jitter buffer 220 is flushed at block 506, the playback rate of the video and audio content is decreased at a block 508. In one implementation, the stream analysis filter 406 may be directed to decrease the playback rate of the video and audio content. As a result, the home network device 122 will render the media content at the reduced rate while the content is arriving at the home network device 122 at the previous unreduced rate. Thus media content is arriving at the home network device 122 faster than it is being rendered by the home network device 122. The resulting backlog of undecoded media content may be used to build the jitter buffer 220 at a block 510. In one exemplary implementation, when the media content is being rendered on a monitor using NTSC, the media playback rate can be reduced from 30 frames per second to 24 frames per second, allowing the jitter buffer to be built in 5-10 seconds. During this time, the media content may be shown on a monitor and/or played over speakers rendering a good user experience. In addition, the backlog of undecoded media content may also exert a back pressure in the entertainment server 112, forcing the upstream filters 402 to store media content in a pause buffer.

The status of the jitter buffer 220 is monitored by a loop including blocks 510 and 512. Status reports sent from the home network device 122 may include, among other information, the status of the jitter buffer 220. If these status reports indicate that the jitter buffer is not yet built (i.e. the “no” branch from block 512), the method 500 continues building the jitter buffer (block 510). Once the jitter buffer 220 is built (i.e. the “yes” branch from block 512), and it is determined to hold enough media content to safely protect the user experience from being interrupted or deleteriously affected by network anomalies, the home network device 122 will send a status report confirming the built status of the jitter buffer 220 to the entertainment server 112. When this is received by the entertainment server 112, the method 500 may begin playing the media content at a normal playback rate (i.e. not the reduced playback rate) at a block 514. The method 500 may then return to a block 502 where it may continuously monitor the streaming process and wait for another latency inducing event.

### Method of Filter Graph Use

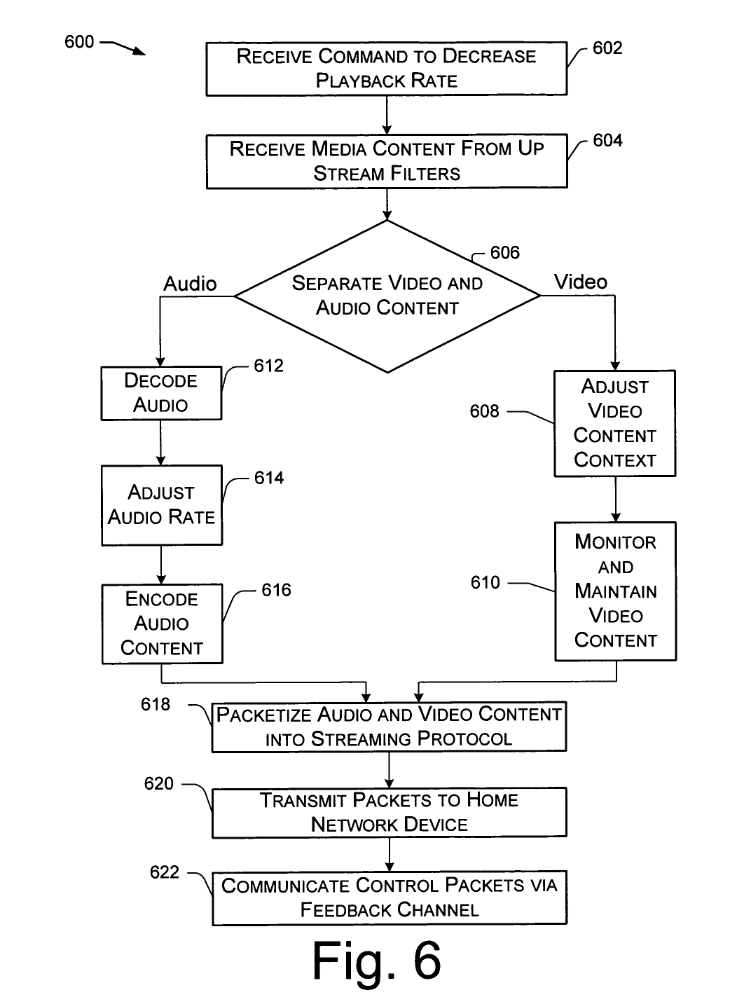

Another aspect of decreasing the effects of latency inducing events on streaming media is shown in FIG. 6, which illustrates an exemplary method 600 performed by the filter graph 304 residing at the entertainment server 112. For ease of understanding, the method 600 is delineated as separate steps represented as independent blocks in FIG. 6; however, these separately delineated steps should not be construed as necessarily order dependent in their performance. Additionally, for discussion purposes, the method 600 is described with reference to elements in FIGS. 1-4.

When a latency inducing event such as a channel change, a stopping and starting of the streaming of live media content, or transrating to different streaming rates occurs during the streaming of media content, a command may be received by the filter graph 304 at a block 602 instructing the filter graph 304 to change the video and audio context and slow down the playback rate of the stream of media content.

To effect this command, media content received in the filter graph 304 via upstream filters 402 at a block 604 may be separated into corresponding video content and audio content at a block 606. In one exemplary implementation, the media content received via the upstream filters 402 may be encoded and compressed in an MPEG 2 format. Alternately, the media content may also be encoded and compressed in other formats as well.

The video content may have its context adjusted at a block 608. This may entail the insertion of new video sequence headers into the packets making up the video content informing the decoder 222 in the home network device 122 that a new frame rate has been selected. In addition, video presentation timestamps on the video content packets may be normalized to the new frame rate.

If the video content has been encoded in an MPEG 2 format, the possible playback rates include 24, 25, 29.997, 30 and 60 frames per second. Thus, if media content which was originally received by the entertainment server 112 in the NTSC format, by reducing the frame rate to 24 frames per second, a 20% reduction in the playback rate at the home network device 122 can be realized. Similarly, if a reduction to 25 frames per second is selected, a reduction in the playback rate at the home network device 122 of 16.667% may be realized.

The video content being transmitted through the filter graph 304 may also be monitored and maintained at a block 610. For example, after a latency inducing event occurs, discontinuities in the video content stream may adversely affect downstream decoders such as the decoder 222 in the home network device 122. This may be averted at block 610 by dropping frames in the video content stream until an iframe or a clean point in the video stream is reached. This ensures that after home network device 122 has flushed its buffers in response to a latency inducing event, the first frame it receives from the filter graph 304 is an iframe or a clean point in the stream.

After being separated out from the media content at block 606, the audio content may be decoded at a block 612. In one exemplary implementation, the audio content may be decoded from an MPEG-2 format into audio PCM samples. The decoded audio content may then have its context altered at a block 614 such that the new playback rate of the audio content will equal that chosen for the video content at block 608. If the audio content has been decoded into audio PCM samples, this might entail performing elongation and pitch adjustment on the audio PCM sample. This can be done, for example, using time expansion or VSP methods. In addition, time stamps may also be attached to the audio content at block 614 in order to maintain the synchronization of the audio content and the video content.

Audio content from block 614 may then be encoded into a packet based format, such as the Windows Media Audio (WMA) format, or the MPEG-2 format at a block 616.

The audio content from block 616 and the video content from block 610 may then be packetized into a suitable streaming protocol, such as, RTP, or PTP at a block 618. Once packetized at block 618, the media content may then be streamed over the network 124 to the home network device 122 at a block 620. Media content packets received by the home network device 122 may be decoded and decompressed in the decoder 222 before being transmitted to a player which may render the media content on a monitor 108 or through speakers.

The home network device 122 may also communicate with the filter graph 304 over network 124 through a feedback channel using a defined format or protocol such as real time transport control protocol (RTCP) at a block 622. In such an example, control packets that are separate from data packets may be exchanged between the entertainment server 112 and the home network device 122. In this way control packets from the home network device 122 may provide the entertainment server 112 with information regarding the status of the streaming operation in the form of, for example, buffer fullness reports, or sender's reports. For example, when the jitter buffer 220 has been built, control packets may be sent to the player 306, precipitating a command to the filter graph 304 to speed up the context of the media content to a normal playback rate existing before the command to slow it down was received at block 602.

Audio/Video media control operations, such as user entered commands like start, stop, pause and channel changes, may be communicated over network 124 from the home network device 122 to the entertainment server 112 using a control channel (not shown for the sake of graphic clarity).

It will be understood that the home network device 122 may include a media device interoperating with other media devices through digital living network alliance (DLNA) requirements, as well as Media Center Extender requirements as set forth by the Microsoft Corporation.

As discussed above, reducing the playback rate of the media content by the manner shown in method 600 may speed up the construction of a jitter buffer 220 or a pause buffer in the upstream filters 402. For example, in the instance that an NTSC monitor is being used to display media content, under normal operation a media rendering application on the home network device 122 will render media content at 30 frames per second. Thus the media content will normally be transmitted from the entertainment server 112 to the home network device over the network 124 at 30 frames per second. After a latency inducing event, however, the decoder 222 in the home network device 122 will render the media content at a reduced rate. Thus content may be arriving at the home network device 122 faster than it is being used by the decoder 222 and the media rendering application on the home network device 122. It is this difference in rates that allows a jitter 220 buffer to be built up. In the NTSC example given above, if the media content playback rate is decreased to 24 frames per second, the jitter buffer 220 may be built up in 5-10 seconds while the media content is being rendered on a monitor, maintaining a good quality user experience. Moreover, since 1 second of playtime on the monitor at the reduced playback rate consumes only 24 frames, a jitter buffer 220 requiring 1 second of media content requires less information (24 frames rather than 30 frames required by the normal NTSC playback rate).

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

1. A method, comprising:
receiving a live stream of media content at a server at a first rate;
flushing a jitter buffer upon occurrence of a latency inducing event;
reducing a playback rate of the media content from a second rate to a third rate;
streaming the media content to a network device from the server at a fourth rate greater than the third rate; and
rebuilding the jitter buffer by receiving the media content in the jitter buffer at the fourth rate and consuming the media content from the jitter buffer at the third rate.

2. The method of claim 1, wherein the latency inducing event comprises at least one of a channel change, a stopping and starting of the streaming of live media content, and transrating to different streaming rates.

3. The method of claim 1, further comprising returning the playback rate to the second rate after receiving notice that the jitter buffer has been rebuilt.

4. The method of claim 1, further comprising smoothing various network anomalies through the use of media content from the jitter buffer to maintain quality of a user experience.

5. The method of claim 1, further comprising building a pause buffer on the server to store the media content being built up as a result of a slowdown in consumption of the media content from the jitter buffer.

6. The method of claim 1, further comprising ensuring that a stream of media content introduced to the network device after the jitter buffer is flushed starts with an iframe or a clean point in the video stream.

7. A server comprising:
a player module to stream media content at a transmission rate to a remote device for playback on the remote device at a playback rate;
a latency correction tool to respond to a latency inducing event and direct the remote device to reduce the playback rate from a normal playback rate to a reduced playback rate to build up a buffer.

8. The computer system of claim 7, wherein the normal playback rate comprises one of 25 or 30 frames per second.

9. The computer system of claim 7, wherein the reduced playback rate comprises 24, 25, and 29.997 frames per second.

10. The computer system of claim 7, wherein the buffer resides on the server.

11. The computer system of claim 7, wherein the buffer comprises a jitter buffer residing on the remote device.

12. The computer system of claim 7, wherein the buffer smoothes various network anomalies which might otherwise introduce glitches into a streaming of the media content and adversely affect a user experience.

13. The computer system of claim 7, wherein the server is configured to return the playback rate of the media content to the normal playback rate once the buffer has been built.

14. A computer-readable medium having a set of computer-readable instructions that, when executed, perform acts comprising:
receiving a stream of media content from a source at a reception rate;
transmitting the stream of media content to a remote device at a transmission rate; and
informing the remote device upon detection of a latency inducing event that a new frame rate has been selected for the stream of media content.

15. The computer-readable media of claim 14, wherein the set of computer-readable instructions are further configured to separately change a context of the video and audio.

16. The computer-readable media of claim 14, wherein the set of computer-readable instructions are further configured to insert new video sequence headers into packets making up video content informing the remote device that a new frame rate has been selected.

17. The computer-readable media of claim 14, wherein the set of computer-readable instructions are further configured to normalize video presentation timestamps on video content packets to a new frame rate.

18. The computer-readable media of claim 14, wherein the set of computer-readable instructions are further configured to receive control packets from the remote device containing buffer fullness reports, or sender's reports.

19. The computer-readable media of claim 14, wherein the set of computer-readable instructions are further configured to store excess media content in a reservoir when the reception rate exceeds the transmission rate.

20. The computer-readable media of claim 19, wherein the set of computer-readable instructions are further configured to read excess media content from the reservoir when the transmission rate exceeds the reception rate.
